(19) United States
(12) Patent Application Publication
(10) Pub. No.: US 2008/0239285 A1
(43) Pub. Date: Oct. 2, 2008

(54) Fingerprint identification system

(75) Inventors: Meng-Hua Wang, Taichung City (TW); Tzu-Te Wang, Tainan City (TW)

Correspondence Address: TROXELL LAW OFFICE PLLC, 5205 LEESBURG PIKE, SUITE 1404, FALLS CHURCH, VA, 22041, US

(73) Assignee: CHUAN LIANG INDUSTRIAL CO., LTD.

(21) Appl. No.: 11/730,355

(22) Filed: Mar. 30, 2007

(51) Int. Cl. G06K 9/74

(52) U.S. Cl. 356/71

(57) ABSTRACT

A fingerprint ID system providing function of compressed volume of the fingerprint ID system is comprised of adding a reflection device group between fingerprint plane of the device pervious to light and imaging plane of an image sensor; and the device pervious to light and a flat reflection plane group is integrated into one device for reducing the size of the fingerprint ID system and significantly upgrading automated precision assembly and easier alignment of devices to effectively reduce production cost and shorten production cycle.

### BACKGROUND OF THE INVENTION

(a) Field of the Invention

The present invention is related to a fingerprint ID system, and more particularly, to one that achieves compressing system volume effects by using a new method to transit optical path.

(b) Description of the Prior Art

Existing fingerprint ID systems generally apply and integral prism, convex lens and image sensor device as the primary devices to catch image of fingerprint. FIG. 1 of the accompanying drawings is a schematic view of a fingerprint ID system of the prior art. Wherein, a visible beam emitted from a light source 11 enters into one side of a prism 12 and advances in the prism 12 heading for a fingerprint side 121 that contacts a finger 10 while reflecting an image formed by having the finger 10 to contact the fingerprint side 121 to another side of the prism 12; in turn the image is focused through a convex lens 13 on an image sensor 14 before executing proper signal process to complete identification of fingerprint.

The optical path involved reveals a number of flaws about the prior art. Size, among others, is a problem. There is a lot of space in the fingerprint ID system of the prior art not fully utilized due to that the light travels in straight line fashion. As illustrated in FIG. 1, other than the section of the optical path from the fingerprint contact side 121 to the image sensor 14, the light advances in straight line. For being restricted by optical characteristics including focusing, it is difficult for the fingerprint ID system of the prior art to have breakthrough in reducing its installation size.

In another fingerprint ID system of the prior art as illustrated in FIG. 2 showing a different optical path, a visible beam emitted from a light source 21 enters into one side of a wedge shaped device 22 pervious to light instead of through the prism 12 as found with the prior art illustrated in FIG. 1. The device 22 pervious to light is characterized in that it is capable of defining both of a light input plane and a light output plane of the reflecting light on the same plane through angular adjustment. The beam advances in the device 22 pervious to light towards a fingerprint side 221 where contacts a finger 20 and reflects an image formed on the surface where the finger 20 contacts the fingerprint side 221 out of the device 22 pervious to light; and then the image so reflected passes through one or a plurality of convex lens 23 to focus on an image sensor 24 before executing proper signal process to complete the fingerprint ID cycle. Though the fingerprint ID system illustrated in FIG. 2 does reduce the size between the light source 21 and the device 22 pervious to light, the problem of direct impacts from the imaging optical path between the fingerprint side 221 and the image sensor 24 remains unsolved.

Another problem found with the prior art is also attributable to optical characteristics. Since the beam must be focused on the image sensor 24 through the convex lens, any error of relative positions among the device 22 pervious to light, the convex lens, and the image sensor 24 would result in poor focusing, thus leading to poor image signals. Therefore, those relative positions among the device 22 pervious to light, the convex lens, and the image sensor 24 must be precisely accurate, a demand that is very difficult to meet due to that the assembly of those devices is done in an automated manufacturing process. The assembly and test in turn must be done manually, and naturally the production time required is longer, and higher production output is prevented for manual operation of precise assembly and test. Furthermore, product acceptance rate may be a problem since the manual assembly is not necessarily reliable.

In coping with those flaws found with the fingerprint ID systems of the prior art described above, a solution of applying new method to integrate device pervious to light, convex lens, and image sensor is needed for the fingerprint ID system.

### SUMMARY OF THE INVENTION

The primary purpose of the present invention is to provide a fingerprint ID system to solve problems found with the prior art including failure in effective reduction in size due to optical limitations, longer production cycle, and lower production output and acceptance rate due to pursuit of device precise alignment at the cost of shifting to manual assembly and test.

To achieve the purpose, a group of reflection devices is added to where between the fingerprint side of a device pervious to light and an imaging side of an image sensor for the present invention to provide the function of compressed fingerprint ID system volume, thus for the system to achieve optimal use of the space in a reduced volume to facilitate its adaptation to portable products including iron rolling door RC, handset, PDA, and notebook.

In the configuration as described above, the present invention further utilizes its free area pervious to light to integrate the device pervious to light and a flat reflection plane group into a device, so to reduce the size of the fingerprint ID system and significantly upgrade automated precision assembly and ease of alignment among devices for effectively lowering production cost and cycle.

The present invention discloses a fingerprint ID system including a light source, a wedge shaped device pervious to light, a reflection device group, a lens unit, and an image sensor. Wherein, the device pervious to light made of either of glass or plastic material pervious to light, or the combination of both. The device pervious to light is provided with a fingerprint side to contact a finger and a beam outlet side; both sides define a range of angles between 0°˜45° and are controlled to retrieve a fingerprint image of total internal reflection; and the beam emitted from the light source directly irradiates on the fingerprint side before the fingerprint is reflected. The purpose of the reflection device group is to reflect the beam carrying the image of the fingerprint. The lens unit is comprised of one or a plurality of spherical lens, aspherical lens, and diffraction device to focus the final beam reflected by the reflection device group to form an image. The image sensor is provided to receive the image.

Wherein, the reflection device group is comprised of multiple film plated flat reflection planes with the angle and position to place each reflection plane meeting the imaging principles of flat mirror; and the last flat reflection plane reflects the beam into the lens unit for the image to be formed on the image sensor.

The angle and position to place each reflection plane in the reflection device group meet the formula described as: δ+180°×m=Φ−2Φ₁−2Φ₂− . . . −2Φₙ. Wherein m= . . . −2, −1, 0, 1, 2 . . . ; δ, an included angle defined by the optical axis of the lens unit and a plumb line; Φ, an included angle defined by a central beam reflected from the fingerprint side and a plumb line; and Φ1˜Φn, included angles respectively defined by 1^{st}˜n^{th} film plated flat reflection planes and a horizontal line.

In another preferred embodiment of the present invention, the reflection device group is comprised of one or a plurality of spherical lens, aspherical lens, and flat film plated reflection plane so that while reflecting a beam of fingerprint image the reflection device group also focuses to form an image thus to skip the installation of the lens unit as found with the first preferred embodiment of the present invention. Again, the angle and position to place each reflection plane must meet the imaging principles of flat mirror; and the last reflection plane reflects the beam to form the image on the image sensor.

Another preferred embodiment yet of the present invention is characterized in having the device pervious to light and the reflection device group into a free-form prism. Wherein, the fingerprint ID system includes a light source, a free-form prism made either of glass or plastic material pervious to light or combination of both. The free-form prism is provided with a fingerprint side to contact a finger and the beam emitted from the light source directly irradiates on the fingerprint side before reflecting the image of the fingerprint. The angle between the fingerprint side and the beam from the light source is controlled to retrieve the fingerprint of total internal reflection. On one side of the free-form prism is disposed with an total internal reflection plane group to such that the optical path of the reflected beam is located inside the free-form prism; a lens unit comprised of one or a plurality of spherical lens, aspherical lens, and diffraction device so that the final beam reflected by the reflection device group is focused to form an image; and an image sensor to receive the image formed. Wherein, the total internal reflection plane group is comprised of multiple flat reflective planes; and the angle and position of each total internal reflection plane must meet the imaging principles of a flat mirror with the last internal reflection plane to reflect stream of light into the convex lens to finally form an image on the image sensor device. A reflection device related to a film plated flat reflection plane is further disposed to each total internal reflection plane in the total internal reflection plane group to enhance the total reflection results.

The angle and position of each total internal reflection plane in the total internal reflection plane group meet the formula described as δ+180°×m=Φ−2Φ₁−2Φ₂− . . . −2Φₙ; wherein, m= . . . −2, −1, 0, 1, 2 . . . ; δ, an included angle defined by optical axis of the lens unit and a plumb line; Φ, an included angle defined by a central beam reflected from the fingerprint side and a plumb line; and Φ1˜Φn, included angles respectively defined by 1^{st}˜n^{th} film plated flat reflection planes and a horizontal line; Φ1˜Φn, included angles respectively defined by 1^{st}˜n^{th} total internal reflection planes and a horizontal line; and the total internal reflection constrains formula described as θ_{c}=sin⁻¹(nₐᵢᵣ/nᵢ); wherein θ_{c} is an total internal reflection critical angle of the material of the free-form prism; nₐᵢᵣ, the refractive index of air; nᵢ, and the refractive index of the free-form prism; and θ_{c}, the total internal reflection is determined by the material of the free-form prism. In this preferred embodiment, the total internal reflection group is comprised of one or a plurality spherical lens, aspherical lens, and film plated flat reflection plane to focus for image formation while reflecting the beam of the fingerprint image. Accordingly, the installation of the lens unit is not required. The angle and position of each total internal reflection plane within the total internal reflection group must meet imaging principles of flat mirror with the last total internal reflection plane to reflect the beam to form the image on the image sensor.

### BRIEF DESCRIPTION OF THE DRAWINGS

FIG. 1 is a schematic view showing a fingerprint ID system of the prior art;

FIG. 2 is a schematic view showing another fingerprint ID system of the prior art;

FIG. 3 is a schematic view showing a size of a construction of an example taken from the system as illustrated in FIG. 2;

FIG. 4 is a schematic view showing a first preferred embodiment of a fingerprint ID system of the present invention;

FIG. 5 is a schematic view showing a size of a construction of the first preferred embodiment of the present invention;

FIG. 6 is a schematic view showing a second preferred embodiment of the present invention;

FIG. 7 is a schematic view showing a third preferred embodiment of the present invention;

FIG. 8 is a schematic view showing the third preferred embodiment is adapted with an additional reflection device attaching flushed onto an total internal reflection plane; and

FIG. 9 is a schematic view of a fourth preferred embodiment of the present invention.

### DETAILED DESCRIPTION OF THE PREFERRED EMBODIMENTS

Referring to FIG. 4 for a schematic view of a first preferred embodiment of the present invention, a fingerprint ID system includes a light source 31 to directly irradiate beams on a wedge shaped device 32 pervious to light, and the device 32 is made either of glass or plastic material, or a combination of both. A fingerprint side 321 contacts a finger 30 is disposed on the device 32 to retrieve an total internal reflection fingerprint image by controlling an angle θ defined by the fingerprint side 321 and a beam output side 322 of the device 32. The angle θ ranges between 0°˜45° and an included angle defined by the light output side 322 and a bottom of the system is not necessarily at a right angle thus to reduce the volume of conventional device pervious to light in the fingerprint ID system. A reflection device group 35 is disposed behind the device 32 pervious to light for the purpose to allow transit of beams fully utilize the space. The final beam arrives at a lens unit 33 to focus for image formation on an image sensor 34. Wherein, the reflection device group 35 is comprised of one or a plurality of film plated flat reflection plane (a first reflection plane 351, a second reflection plane, . . . and a n^{th} reflection plane 35n) while the lens unit 33 is comprised of one or a plurality of spherical lens, aspherical lens, and diffraction device.

In this preferred embodiment, the reflection device group 35 is placed at a position meeting the following formula (referring to FIG. 1):

δ+180°×m=Φ−2Φ₁−2Φ₂− . . . −2Φₙ (Formula 1)

Wherein m= . . . −2, −1, 0, 1, 2 . . . ; δ=an included angle defined by an optical axis of the lens unit and a plumb line; Φ=an included angle defined by a central line of the beams as reflected from the fingerprint side 321 and a plumb line; Φ₁˜Φₙ are included angles respectively defined by the 1^{st}˜n^{th} film plated reflection side 351 and a horizontal line.

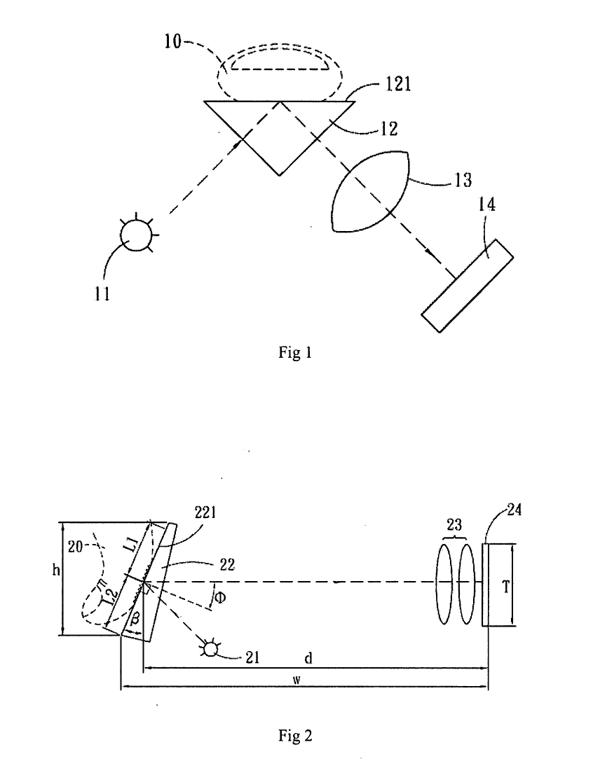

Accordingly, referring to FIGS. 2 and 4, length and height of the volume of a compressed fingerprint ID system of the present invention when compared with that of the prior art in a given situation is expressed by the following formula.

If as illustrated in FIG. 2, supposing that L1 cos β>T/2 (L1, the length of the upper half of the fingerprint side 221, and β, an angle defined by the fingerprint side 221 and the light output side); then the length of the system of the prior art w=L2·sin β+d (L2 is the length of the finer half of the fingerprint side 221; and d the length of an optical path from the fingerprint side 221 to the image sensor 24); then the height of the system of the prior art is·h=(L1+L2)·cos β (the sum of L1+L2 is the length of the fingerprint side 221).

As illustrated in FIG. 4, when those devices described above are added into the reflection device group 35, then the length of the optical path from the fingerprint side 321 to the image sensor 34 is solved by d=d1+d2+ . . . +dn (wherein, d1 is the length of optical path from the fingerprint side 321 to the first reflection plane 351; d2, the length of optical path from the first reflection plane 351 to the second reflection plane 352, and so on until dn, the length of optical path from the n^{th} reflection plan 35n to the image sensor 34), thus the system length of the present invention is solved byw′=L2+d1 sin(Φ)+d2 sin(Φ−2 Φ₁)+ . . . +dn sin(Φ−2Φ₁− . . . −2Φₙ₋₁)+T/2 (T is the length of the image sensor 34); and the height of the present invention h′=dn. Therefore, when compared to the prior art, the present invention is reduced for □w=w−w′ in length, and □h=h−h′ in height.

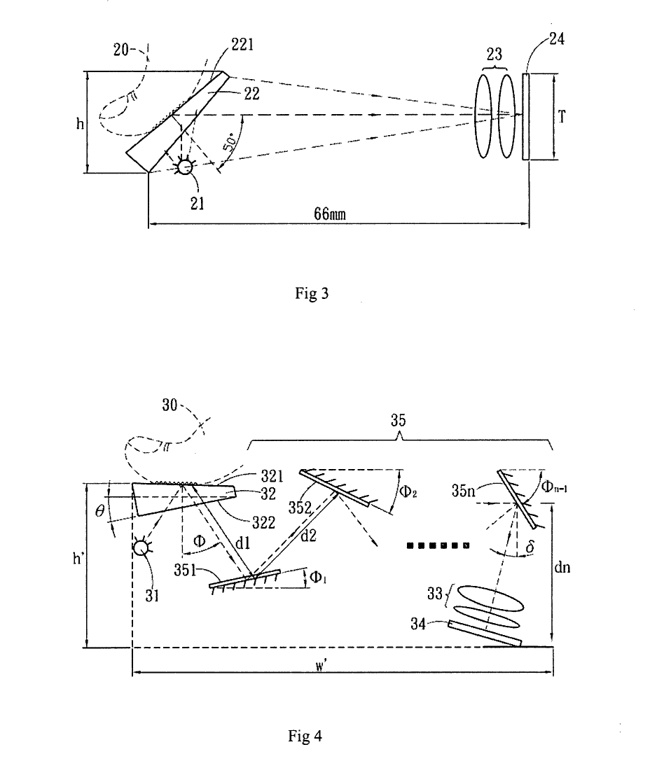

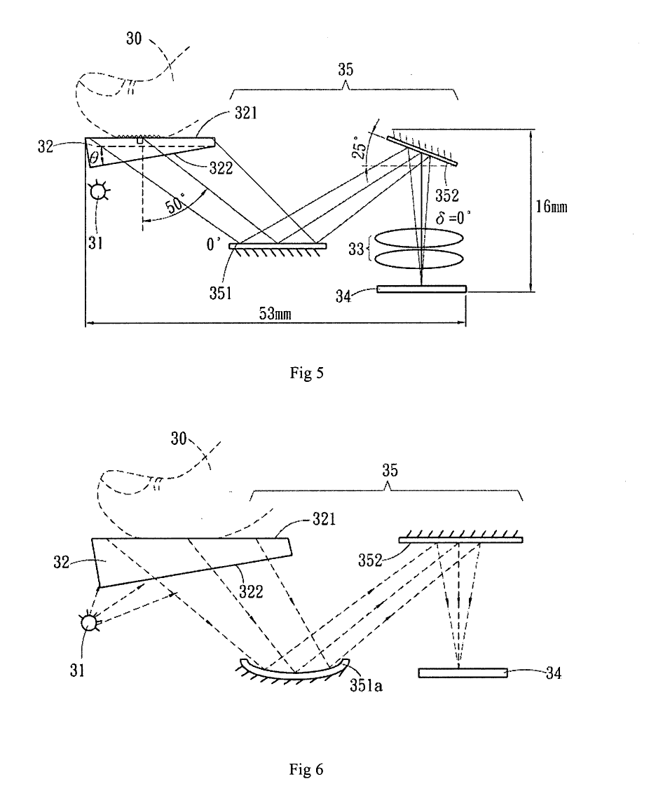

By comparing between FIGS. 3 and 5, the effects of the present invention to achieve physical reduction become apparent. Given with the same condition of Φ=50° in both cases, the reflection device group 35 includes the first reflection plane and the second reflection plane 352; and when Φ₁=0° and δ=0°, the real length is reduced from 66 mm as measured from the prior art to 53 mm, and the height is also reduced from 19 mm as measured with the prior art to 16 mm of the present invention with the images respectively retrieved by the prior art and the present invention identical in size and quality.

The present invention provides the function of compressed fingerprint ID system volume by placing the reflection device group 35 at where between the fingerprint side 321 of the device 32 pervious to light and the image sensor 34 for the system to effectively utilize the space to achieve volume reduction results.

In a second preferred embodiment of the present invention, it differs from the first preferred embodiment given in FIG. 4 in that the refection device group in the second preferred embodiment the reflection device group 35 is comprised of one or a plurality of spherical lens, aspherical lens and a film plated flat reflective plane. Wherein, the angle and position to place the reflection device group 35 must meet the imaging principles of a mirror with the final reflection plane further reflecting the stream of light to form an image on the image sensor 34 so to reflect the beams of the fingerprint image while focusing the beams for image formation. Accordingly, the installation of the lens unit 33 is not required in this second preferred embodiment of the present invention. The angle and position to place each single reflection plane within the reflection device group 35 must meet the imaging principles of a mirror with the final reflection plane further reflecting the stream of light to form an image on the image sensor 34. As illustrated in FIG. 6, the original first reflection plane 351 is replaced with a concave reflection plane 351a. The concave reflection plane 351a provides the function of focusing to form image. In this preferred embodiment, the concave reflection plane 351 reflects beams of the fingerprint image to focus for forming the image before the beams are reflected to form the image on the image sensor 24.

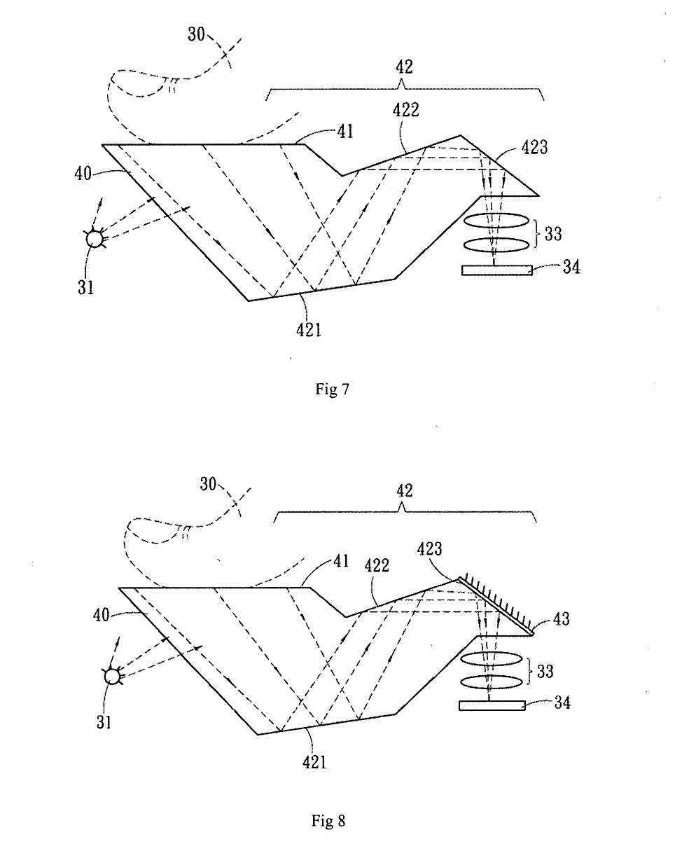

Now referring to FIG. 7 for a third preferred embodiment of the present invention, wherein the device 32 pervious to light and the reflection device group 35 are integrated into a free device 40 pervious to light made of either glass, or plastic material pervious to light, or the combination of both. In practice, the system includes a light source 31 to directly irradiate beams on a fingerprint side 41 of the free device 40 pervious to light, and an total internal reflection fingerprint image is retrieved by means of controlling the incidental angle from the light source 31. An total internal reflection group 42 is disposed on one side of the free device 40 pervious to light (e.g., a first total internal reflection plane 421, a second total internal reflection plane 422, and a third total internal reflection plane 423 as illustrated in FIG. 7) to have a path of the reflection light to be located inside the free device 10 pervious to light and further to achieve the mirror imaging results by taking advantage of total internal reflection. The results are realized as described in formula 1, the angle and position of each total internal reflection plane with the total internal reflection group meet the formula described as δ+180°×m=Φ−2Φ₁−2Φ₂− . . . −2Φₙ, wherein, m= . . . −2, −1, 0, 1, 2 . . . ; δ= an included angle defined by the optical axis of the lens unit and the plumb line; Φ=an included angle defined by the beam of the central line of the beams outputted from the fingerprint side and the plumb line; and Φ1˜Φn relate to included angles respectively defined by the 1^{st}˜n^{th} total internal reflection group and the horizontal line. Furthermore, the total internal reflection constrains formula described as θ_{c}=sin⁻¹(nₐᵢᵣ/nᵢ) are also met, wherein θ_{c} [symbol] refers to an critical angle of total internal reflection in the material of the free device 40 pervious to light; nₐᵢᵣ, the refraction index of air; nᵢ, the refraction index of the free device 40 pervious to light; and θ_{c}, the total internal reflection critical angle is determined by the material of the free device 40 pervious to light. For all the streams of light arriving from the fingerprint side 41 at the lens unit 33 to focus for image information on the image sensor 34, any reflection plane designed must be capable of having the angle of all imaging beams not smaller than the total internal reflection critical angle, and the lens unit 33 same at that used in the first preferred embodiment is comprised one or a plurality spherical lens, aspherical lens, and diffraction device.

Accordingly, by having integrated a light pervious area of the free device 40 pervious to light and the reflection device group into one device, the size of the fingerprint ID system is reduced and automated precision assembly and ease of alignment among devices are significantly upgraded to effectively lower production cost and cycle.

As illustrated in FIG. 8, the fingerprint ID system differs as illustrated in FIG. 7 in further disposed with an additional reflection device 43 attaching flushed on each total internal reflection plane within the total internal reflection group 42 so to enhance the results of total reflection. As illustrated, the third total internal reflection plane 423 is attached flushed with the reflection device 43 so that the stream of light arriving on the third total internal reflection plane 423 is not necessarily equal to or greater than the total internal reflection critical angle, thus to enhance the total reflection results given by the third total internal reflection plane 423.

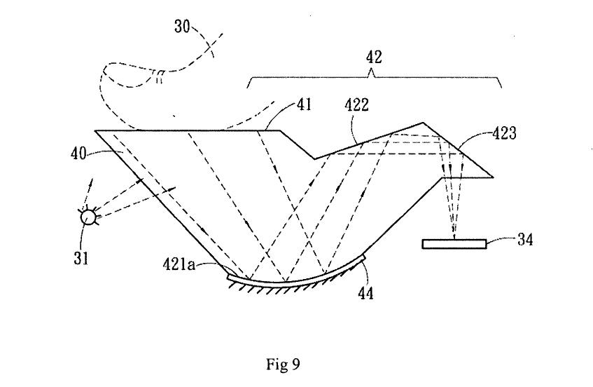

A fourth preferred embodiment of the present invention as illustrated in FIG. 9 differs from the third preferred embodiment in that the total internal reflection group 42 of the free device 40 pervious to light is comprised of one or a plurality of spherical lens, aspherical lens, and film plated flat refection plane. As illustrated in FIG. 9, the first total internal reflection plane 421 is changed to an aspherical concave reflection plane 421a, and a curved reflection device 44 attaches flushed onto the concave reflection plane 421a for the concave reflection plane 421a to provide the function of focusing to form image. Therefore, the lens unit 33 is not required in the fourth preferred embodiment. Again, both angle and position of each total internal reflection plane within the total internal reflection group 42 must meet the mirror imaging principles with the last total internal reflection plane to further reflect streams of light to form image on the image sensor 34.

Whereas installation of the lens unit 33 is not required and the curved reflection device 44 actually attaches flushed onto the free device 40 pervious to light, further reduction in the number of devices in the assembly is achieved to further significantly upgrade automated precision assembly and ease of alignment of devices to effectively lower production cost and cycle.

The prevent invention provides an improved structure of a fingerprint identification system, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A fingerprint identification system including a light source; a wedge shaped device pervious to light and provided with a fingerprint side for a finger to contact and a beams outputted side, the beams from the light source directly irradiating on the fingerprint side before reflecting an image of the fingerprint; a reflection device group to reflect beams carrying the fingerprint image; a lens unit for the final beam reflected by the reflection device to focus for image formation; and an image sensor to receive imaging.

2. The fingerprint identification system as claimed in claim 1, wherein the light permeable device is made either of glass or plastic material pervious to light, or a combination of both.

3. The fingerprint identification system as claimed in claim 1, wherein the angle defined by the fingerprint side and the beam outputted side ranges between 0°˜45°, and is controlled to retrieve an total internal reflection fingerprint image.

4. The fingerprint identification system as claimed in claim 1, wherein the reflection device is comprised of one or a plurality of coating planar reflectors.

5. The fingerprint identification system as claimed in claim 5, wherein the angle and position to place each reflection plane within the reflection device group meet the law of Reflection; and the last reflective plane reflects streams of light into the lens unit to eventually form an image on the image sensor.

6. The fingerprint identification system as claimed in claim 5, wherein, the angle and position to place each reflection plane within the reflection device group meets a formula described as δ+180°×m=Φ−2Φ₁−2Φ₂− . . . −2Φn, wherein m= . . . −2, −1, 0, 1, 2 . . . ; δ=an included angle defined by the optical axis of the lens unit and a plumb line; Φ=an included angle defined by the stream of light of the central beams outputted from the wedge shaped device pervious to light and a plumb line; Φ1˜Φn refer to those included angles respectively defined by the 1^{st}˜n^{th} film plated reflection plane and a horizontal line.

7. The fingerprint identification system as claimed in claim 1, wherein the lens unit is comprised of one or a plurality of spherical lens, aspherical lens, and diffraction device.

8. A fingerprint identification system includes a light source, a wedge shaped device pervious light provided with a fingerprint side for a finger to contact, and a light outputted side; the beams emitted from the light source directly irradiates on the fingerprint side before reflecting the fingerprint image; and a reflection device group to reflect beams carrying the fingerprint image to focus for formation of the image; and an image sensor to receive the imaging.

9. The fingerprint identification system as claimed in claim 8, wherein the light permeable device is made either of glass or plastic material pervious to light, or a combination of both.

10. The fingerprint identification system as claimed in claim 8, wherein the angle defined by the fingerprint side and the beam outputted side ranges between 0°˜45°, and is controlled to retrieve an total internal reflection fingerprint image.

11. The fingerprint identification system as claimed in claim 8, wherein the total internal reflection group is comprised of one or a plurality of spherical, aspherical and coating reflection surfaces.

12. The fingerprint identification system as claimed in claim 8, wherein the angle and the position of placing each reflection plane within the reflection plane group meet the Law of reflection with the last reflection plane to reflect streams of light to form image on the image sensor.

13. A fingerprint identification system includes a light source, a free-form prism provided with a fingerprint side for a finger to contact, the beams emitted form the light source directly irradiates on the fingerprint side before reflecting a fingerprint image, an total internal reflection group is provided on one side of the free-form prism to allow the optical route of the reflection beam locate inside the free-form prism; a lens unit to allow final beams reflected by the total internal reflection group to focus for imaging; and an image sensor to receive the imaging.

14. The fingerprint identification system as claimed in claim 13, wherein the free-form prism includes either of glass or plastic material pervious to light, or a combination of both.

15. The fingerprint identification system as claimed in claim 13, wherein the angle defined by the fingerprint side and the imaging beam of the light source is controlled to retrieve an total internal reflection fingerprint image.

16. The fingerprint identification system as claimed in claim 13, wherein the total internal reflection group is comprised of one or a plurality of reflection plane.

17. The fingerprint identification system as claimed in claim 13, wherein the angle and the position of each total internal reflection plane within the total internal reflection plane group meet the Law of Reflection with the last total internal reflection plane to reflect streams of light into the lens unit and eventually to form image on the image sensor.

18. The fingerprint identification system as claimed in claim 13, wherein each total internal reflection plane within the total internal reflection group is further attached flushed with a reflection device to enhance total reflection effects.

19. The fingerprint identification system as claimed in claim 13, wherein the reflection device relates to a coating reflection plane.

20. The fingerprint identification system as claimed in claim 13, wherein the angle and the position of each total internal reflection plane within the total internal reflection plane group meet a formula described as δ+180°×m=Φ−2Φ₁−2Φ₂− . . . −2Φₙ, wherein m= . . . −2, −1, 0, 1, 2 . . . ; δ=an included angle defined by the optical axis of the lens unit and a plumb line; Φ=an included angle defined by the stream of light of the central beams outputted from the fingerprint side and a plumb line; Φ1˜Φn refer to those included angles respectively defined by 1^{st}˜nth total internal reflection planes and a horizontal line; and further meet another formula of total internal reflection constrains described as θ_{c}=sin⁻¹(nₐᵢᵣ/nᵢ), wherein θ_{c} is an total internal reflection critical angle of the material of the free-form prism; nₐᵢᵣ is the refraction index of the air, nᵢ is the refraction index of the free-form prism; and the total internal reflection critical angle θ_{c} is determined by the material of the free-form prism.

21. The fingerprint identification system as claimed in claim 13, wherein the lens unit is comprised of one or a plurality of spherical lens, aspherical lens, and diffraction device.

22. A fingerprint identification system including a light source, a free-form prism provided with a fingerprint side for a finger to contact, the beams emitted from the light source directly irradiates on the fingerprint side before reflecting an image of fingerprint; an total internal reflection group is provided on one side of the free-form prism to reflect the beams carrying the fingerprint image and to focus for imaging; the optical rout of the reflection light being located inside the free-form prism; and an image sensor to receive the imaging.

23. The fingerprint identification system as claimed in claim 22, wherein the light permeable device is made either of glass or plastic material pervious to light, or a combination of both.

24. The fingerprint identification system as claimed in claim 22, wherein the total internal reflection group is comprised of one or a plurality of spherical, aspherical and coating reflection surfaces.

25. The fingerprint identification system as claimed in claim 22, wherein the angle defined by the fingerprint side and the imaging beam of the light source is controlled to retrieve an total internal reflection fingerprint image.

26. The fingerprint identification system as claimed in claim 22, wherein the angle and the position of each total internal reflection surface within the total internal reflection surface group meet the Law of Reflection with the last total internal reflection surface to reflect streams of light to form image on the image sensor.
